(19) United States
(12) Patent Application Publication
(10) Pub. No.: US 2022/0360753 A1
(43) Pub. Date: Nov. 10, 2022

(54) IMAGE PROCESSING DEVICE, DISPLAY SYSTEM, IMAGE PROCESSING METHOD, AND PROGRAM

(71) Applicant: Nippon Telegraph and Telephone Corporation, Tokyo (JP)

(72) Inventor: Takeru Isaka, Musashino-shi, Tokyo (JP)

(21) Appl. No.: 17/770,965

(22) PCT Filed: May 25, 2020
(86) PCT No.: PCT/JP2020/020564

§ 371 Date: Apr. 21, 2022

(30) Foreign Application Priority Data
Oct. 21, 2019 (JP) PCT/JP2019/041295

(51) Int. Cl. H04N 9/31

(52) U.S. Cl. CPC H04N 9/3179; H04N 9/3147

(57) ABSTRACT

A video processing device 10 according to an embodiment outputs a background video 52 producing an induced motion in a visual target 51 on a display surface of a screen 22. The video processing device 10 includes an output unit 13 that outputs the background video 52 surrounding the visual target 51 to a background video output device 21 and a control unit 12 that moves the background video 52 in an opposite direction to a direction in which the visual target 51 is desired to be moved. The background video output device 21 projects the background video 52 to the screen 22.

### TECHNICAL FIELD

The present invention relates to a video processing device, a display system, a video processing method, and a program.

### BACKGROUND ART

As disclosed in PTL 1, NPL 1, and NPL 2, technologies for refracting videos of display devices using optical elements such as half mirrors or transparent plates and displaying mid-air images are known. Since mid-air images are displayed as 2D images on virtual image surfaces in spaces away from physical devices, the mid-air images have a characteristic that there are few clues to be perceived by observers when the mid-air images are planar compared to 2D images displayed on monitors. Using this characteristic, perception of a space orientation indicating that visual targets are at certain positions of the real spaces can be provided simply.

### CITATION LIST

### Patent Literature

[PTL 1] Japanese Patent Application Publication No. 2017-49354

### Non Patent Literature

[NPL 1] N. Koizumi and T. Naemura, “Passive Mid-air Display”, In Proceedings of the 13th International Conference on Advances in Computer Entertainment Technology, Article No. 39, 2016.
[NPL 2] H. Katsumoto, H. Kajita, and T. Naemura, “HoVerTable PONG: Playing Face-to-face Game on Horizontal Tabletop with Moving Vertical Mid-air Image”, In Proceedings of the 13th International Conference on Advances in Computer Entertainment Technology, Article No. 39, 2016.

### SUMMARY OF THE INVENTION

### Technical Problem

Since positions of virtual image surfaces on which visual targets (mid-air images) are displayed are limited by configurations of optical systems, there is a problem that directions in which the visual targets can be moved may be limited within the virtual image surfaces. In other words, it is difficult to perceive visual targets as if the visual targets were moving in normal directions of virtual image surfaces. When visual targets are projected to projection screens, it is also difficult to move the visual targets in normal directions of the projection screens.

In PTL 1, a visual target is moved in a normal direction of a virtual image surface by preparing a plurality of screens from which distances to optical elements are different and switching the screens to which a visual target is projected in accordance with a position to which the visual target is desired to be projected. However, in PTL 1, there is a problem that only a discrete space orientation of a visual target can be expressed. A continuous space orientation of a visual target can be expressed by continuing to physically move a monitor to which the visual target is projected and continuing to move the virtual image surface. However, there is a problem that a large-scale movement mechanism that moves the monitor is necessary and a hardware cost is expensive.

In NPL 2, by physically moving a monitor serving as a light source of a mid-air image, it is possible to express movement of a continuous visual target in a depth direction. In NPL 2, however, since a position of a virtual image surface in a depth direction is a position of a visual target in a depth direction, the number of simultaneously expressible movements of the visual target in the depth direction is limited to one. That is, a plurality of different movements in the depth direction, such as a visual target moving from the front to the depth of an observer and a visual target moving from the depth to the front, cannot be expressed simultaneously.

The present invention has been devised in view of the foregoing circumstances and an objective of the present invention is to express a continuous space orientation of a visual target with a simple configuration.

### Means for Solving the Problem

According to an aspect of the present invention, a video processing device outputs a video of which a movement in a depth direction to a visual target of which a movement in the depth direction is fixed on a display surface of a display device is perceived. The video processing device includes: an output unit configured to output a video corresponding to a position of the visual target to the display device; and a control unit configured to move the video in a direction in which the movement of the visual target in the depth direction is perceived.

According to another aspect of the present invention, a display system includes a plurality of display devices and a video processing device. Each of the plurality of display devices displays a visual target at a position at which projection surfaces above display surfaces of the display devices intersect each other. The video processing device includes an output unit that outputs a background video surrounding the visual target to the display device, and a control unit that moves the background video in an opposite direction to a direction in which the visual target is desired to be moved.

### Effects of the Invention

According to the present invention, it is possible to express a continuous space orientation of a visual target with a simple configuration.

### BRIEF DESCRIPTION OF DRAWINGS

FIG. 1 is a diagram illustrating a configuration of a display system according to a first embodiment.

FIG. 2A is a diagram illustrating a display example of a visual target displayed on a virtual image surface and a background video projected to a screen.

FIG. 2B is a diagram illustrating a display example in which the background video in FIG. 2A is moved.

FIG. 3A is a diagram illustrating a visual target and a background video viewed by an observer in the state of FIG. 2A.

FIG. 3B is a diagram illustrating a visual target and a background video viewed by an observer in the state of FIG. 2B.

FIG. 4 is a diagram illustrating a configuration of a video processing device.

FIG. 5 is a flowchart illustrating a flow of a process of the video processing device.

FIG. 6A is a diagram illustrating a display example of a visual target displayed on a virtual image surface and two background videos projected to a screen.

FIG. 6B is a diagram illustrating a display example in which the two background videos in FIG. 6A are moved.

FIG. 7A is a diagram illustrating the visual target and the two background videos viewed by the observer in the state of FIG. 6A.

FIG. 7B is a diagram illustrating the visual target and the two background videos viewed by the observer in the state of FIG. 6B.

FIG. 8 is a diagram illustrating an example in which a part of the background video is moved.

FIG. 9 is a diagram illustrating a configuration of a display system according to a fourth embodiment.

FIG. 10A is a diagram illustrating a display example of a visual target displayed on a virtual image surface and a shadow projected to a screen.

FIG. 10B is a diagram illustrating how the display state of FIG. 10A appears to an observer.

FIG. 11A is a diagram illustrating a display example of a visual target and a shadow when a visual target object is moved in the depth direction.

FIG. 11B is a diagram illustrating how the display state of FIG. 11A appears to an observer.

FIG. 12 is a flowchart illustrating a flow of a process of the video processing device.

FIG. 13A is a diagram illustrating a display example of a visual target displayed on a virtual image surface and a shadow projected to a screen.

FIG. 13B is a diagram illustrating how the display state of FIG. 13A appears to an observer.

FIG. 14A is a diagram illustrating a display example of a visual target and a shadow when a visual target object is moved in the depth direction.

FIG. 14B is a diagram illustrating how the display state of FIG. 14A appears to an observer.

FIG. 15A is a diagram illustrating an example of how a visual target appears in a display system.

FIG. 15B is a diagram illustrating an example of how a visual target appears when a depth position of the visual target is different from that of FIG. 15A.

FIG. 16A is a diagram illustrating an example of how a plurality of visual targets appear when depth positions of the visual targets are different.

FIG. 16B is a diagram illustrating an example of how the visual targets appear when the depth positions of the visual targets are different from those of FIG. 16A.

FIG. 17 is a diagram illustrating a display example of a visual target displayed on a virtual image surface and a shadow projected to a screen.

FIG. 18 is a diagram illustrating how the display state of FIG. 17 appears an observer on the right side.

FIG. 19 is a diagram illustrating a display example of a visual target displayed on a virtual image surface and a shadow projected to a screen.

FIG. 20 is a diagram illustrating how the display state of FIG. 19 appears to an observer on the right side.

FIG. 21A is a diagram illustrating an example of how an upper portion of a visual target appears from the front when illuminated with a spotlight.

FIG. 21B is a diagram illustrating an example of how the upper portion of the visual target appears from the right when illuminated with a spotlight.

FIG. 22A is a diagram illustrating an example of how upper portions of a plurality of visual targets appear from the front when illuminated with a spotlight.

FIG. 22B is a diagram illustrating an example of how the upper portions of the plurality of visual targets appear from the right when illuminated with the spotlight.

FIG. 23 is a diagram illustrating an example of a hardware configuration of a video processing device.

### DESCRIPTION OF EMBODIMENTS

### First Embodiment

A display system according to a first embodiment will be described with reference to the drawings.

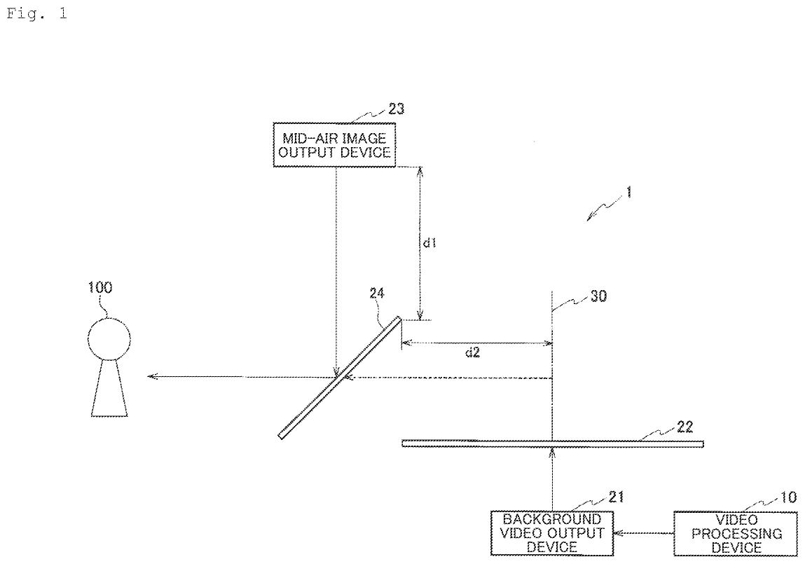

A display system 1 illustrated in FIG. 1 includes a video processing device 10, a background video output device 21, a screen 22, a mid-air image output device 23, and an optical element 24. In the display system 1, a mid-air image (hereinafter referred to as a “visual target”) is displayed on a virtual image surface 30 by the mid-air image output device 23 and the optical element 24 and the displayed visual target within the background video projected to the screen 22 is perceived to be moved. Specifically, the display system 1 allows an observer 100 to perceive the visual target which is moving in a depth direction or forward under a darkroom condition. The darkroom condition is an environment in which an amount of ambient light surrounding the display system 1 and the observer is small, and preferably no nearby devices are visible.

The screen 22 is disposed in parallel to the ground. The background video output device 21 projects a background video to the screen 22. The background video output device 21 may project a video in any direction.

The optical element 24 is disposed to be tilted at about 45 degrees and the mid-air image output device 23 is disposed above or below the optical element 24. A video output from the mid-air image output device 23 is reflected toward the observer 100 by the optical element 24 to form a mid-air image on the virtual image surface 30. The screen 22 and the optical element 24 are disposed so that the virtual image surface 30 is parallel to a normal direction of the screen 22. By changing a distance d1 between the mid-air image output device 23 and the optical element 24, it is possible to adjust a distance d2 between the optical element 24 and the virtual image surface 30. When the distance d1 becomes short, the distance d2 becomes short. In the embodiment, the mid-air image output device 23 is disposed so that the virtual image surface 30 is near the center of the screen 22. The virtual image surface 30 is not limited to the center of the screen 22 and may be set at any position. The positions of the mid-air image output device 23 and the optical element 24 may be fixed.

The mid-air image output device 23 and the optical element 24 may be able to display a mid-air image on the upper side of the screen 22 and the present invention is not limited to the foregoing configuration. The visual target may not be necessarily displayed to float in the air and may be displayed to be grounded to a display surface of the screen 22. Alternatively, the screen 22 may be disposed on the upper side and a visual target may be displayed to hang on a background video displayed on the screen 22.

Instead of displaying the mid-air image by the mid-air image output device 23 and the optical element 24, a transparent screen may be disposed on the screen 22 and a video transmitted through the transparent screen may be a visual target. Alternatively, a real object may be disposed on the screen 22 and the real object may be a visual target. The positions of the transparent screen and the real object may be fixed.

The video processing device 10 supplies a background video producing an induced motion in the visual target to the background video output device 21. Specifically, the video processing device 10 moves the background video in an opposite direction to the movement direction of the visual target to produce the induced motion in the visual target. The induced motion is a sensory illusion phenomenon giving a motion perception to a stationary object. The background video producing the induced motion is a video surrounding the visual target when the background video is viewed from a viewpoint of the observer 100. In the embodiment, the observer 100 is caused to perceive a floor surface which represents a movement range of the visual target and the visual target which is moving as a background video on the floor surface.

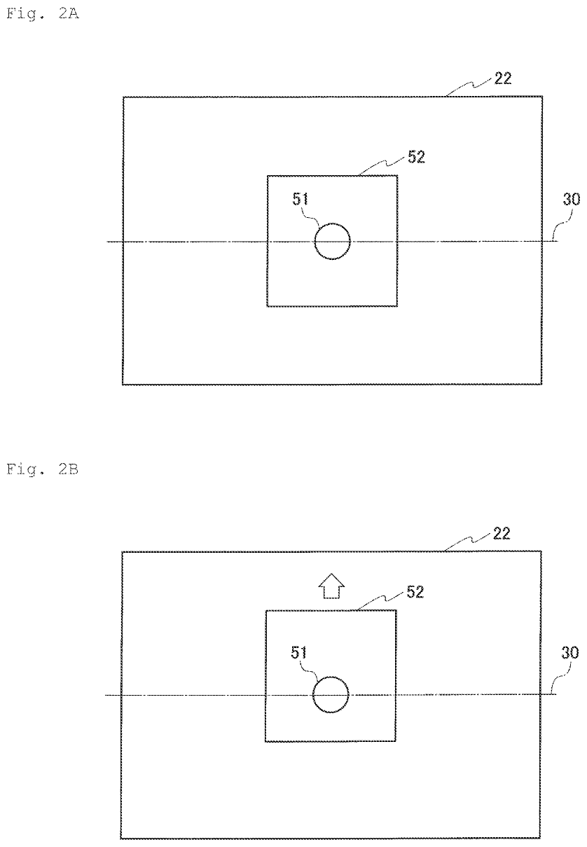

FIG. 2A illustrates a visual target 51 displayed on the virtual image surface 30 and a display example of a background video 52 projected to a screen 22. FIG. 2A is diagram illustrating a bird's-eye view of the screen 22 of FIG. 1. The observer 100 is assumed to be located downward in the drawing. The visual target 51 is projected to the virtual image surface 30, but a position at which the visual target 51 is displayed is expressed as a circle in FIG. 2A. The background video 52 is a video such as a floor surface or the ground surrounding the visual target 51. Any shape, pattern, and color of the background video 52 can be set. Nothing is displayed in a dark state outside of the background video 52.

FIG. 2B illustrates a display example when the background video 52 is moved upward in the drawing from the state of FIG. 2A, that is, to the depth side viewed from the observer 100. The display position of the visual target 51 is not moved. The visual target 51 is moved downward when the background video 52 is set as a reference. When an environment in which the display system 1 is provided is bright and an object such as a frame of the screen 22 or a nearby device for which the position of the background video 52 is understood in the real space is visible, the observer 100 may perceive the background video 52 as moving.

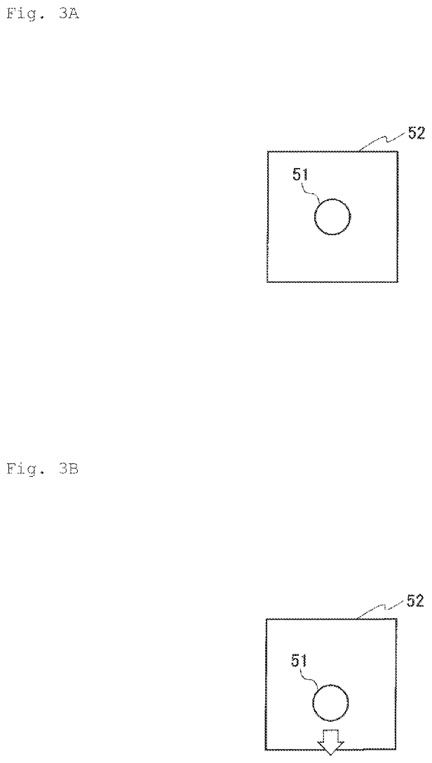

Under the darkroom condition, as illustrated in FIGS. 3A and 3B, the observer 100 gazes at only the visual target 51 and the background video 52. When the background video 52 is moved, the observer 100 perceives the visual target 51 as moving although the background video 52 is actually moving, as illustrated in FIG. 3B. That is, under the darkroom condition, by moving the background video 52 surrounding the visual target 51, it is possible to perform space orientation as if the visual target 51 were moving to any position in the background video 52.

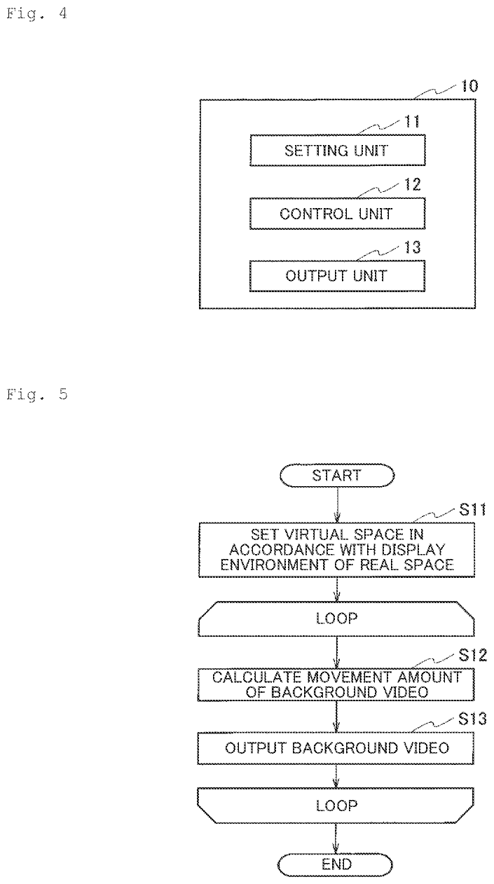

A configuration of the video processing device 10 will be described with reference to FIG. 4. The video processing device 10 illustrated in the drawing includes a setting unit 11, a control unit 12, and an output unit 13.

The setting unit 11 disposes a visual target object indicating a visual target in a visual space and a floor surface object serving as a background video at initial positions based on a positional relation between the screen 22 and the visual target in the real space. For example, the setting unit 11 disposes the floor surface object so that the visual target object stands near the center of the floor surface object. The floor surface object is a plane figure indicating a movement range of the visual target object.

The setting unit 11 disposes a background virtual camera that captures a video to be projected to the screen 22 in the virtual space. The background virtual camera images a region including the floor surface object. A video captured by the background virtual camera is projected to the screen 22. When the position of the virtual camera remains fixed and the floor surface object is moved in the virtual space, a background video projected to the screen 22 is moved.

The setting unit 11 may dispose a visual target virtual camera that images the visual target object. The visual target virtual camera images the visual target object in the lateral direction. The mid-air image output device 23 projects a video captured by the visual target virtual camera to the optical element 24 to display the visual target on the virtual image surface 30.

The control unit 12 moves the floor surface object based on a movement amount of the visual target object. For example, when the visual target is desired to be moved forward a distance v, the control unit 12 moves the floor surface object the distance v in the depth direction. That is, the control unit 12 moves only the floor surface object and does not move the visual target object, the visual target virtual camera, or the background virtual camera. Alternatively, the control unit 12 may not move the floor surface object and may move the visual target object, the visual target virtual camera, and the background virtual camera in the same direction at the same movement amount. In any case, when the floor surface object is moved, a position at which the floor surface object is shown in the video captured by the background virtual camera is moved.

When the visual target can be moved freely in the virtual image surface 30, the control unit 12 may move the background video 52 only in the normal direction of the virtual image surface 30. For example, in the example illustrated in FIG. 2A, when the visual target 51 is moved right and left along the virtual image surface 30, the control unit 12 does not move the background video 52. When the visual target 51 is moved in the vertical direction of the FIG. 2A, the control unit 12 moves the background video 52 with the movement amount of the visual target 51 in the vertical direction.

The output unit 13 outputs a video including the visual target object imaged by the visual target virtual camera to the mid-air image output device 23. The output unit 13 outputs a video including the floor surface object imaged by the background virtual camera to the background video output device 21.

An operation of the video processing device 10 will be described with reference to the flowchart of FIG. 5.

In step S11, the setting unit 11 disposes the floor surface object at the initial position and disposes the virtual camera that images the floor surface object in the virtual space based on a positional relation between the screen 22 and the visual target in the real space. The setting unit 11 may dispose the visual target object and the visual target virtual camera in the virtual space.

In step S12, the control unit 12 calculates a movement amount of the floor surface object corresponding to one frame based on a movement amount of the visual target corresponding to one frame and moves the floor surface object in accordance with the calculated movement amount.

In step S13, the output unit 13 outputs the background video obtained by imaging a plane including the floor surface object using the virtual camera to the background video output device 21. The output unit 13 may output a video obtained by imaging the visual target object using the visual target virtual camera to the mid-air image output device 23.

The processes of steps S12 and S13 are performed for each frame.

As described above, the display system according to the embodiment displays the background video 52 surrounding the visual target 51 on the screen 22 and moves the background video 52 in the opposite direction to the direction in which the visual target 51 is desired to be moved, and thus the observer 100 can perceive the visual target 51 as moving in the background video 52.

### Second Embodiment

Next, a display system according to a second embodiment will be described. A configuration of the display system according to the second embodiment is the same as that of the display system according to the first embodiment.

In general, an induced motion is a phenomenon that arises under a darkroom condition in which an amount of ambient light surrounding the display system and the observer is small. In a real environment, it is difficult to control an amount of light in a facility and completely darken the surroundings of the display system. A nearby device is assumed to be shining and visible to the observer in some cases due to light for display of the visual target, illumination light illuminating the visual target, light output by the visual target itself, or the like. As a result, there is concern of the observer perceiving movement of the background video based on a positional relation between the surrounding device and the background video.

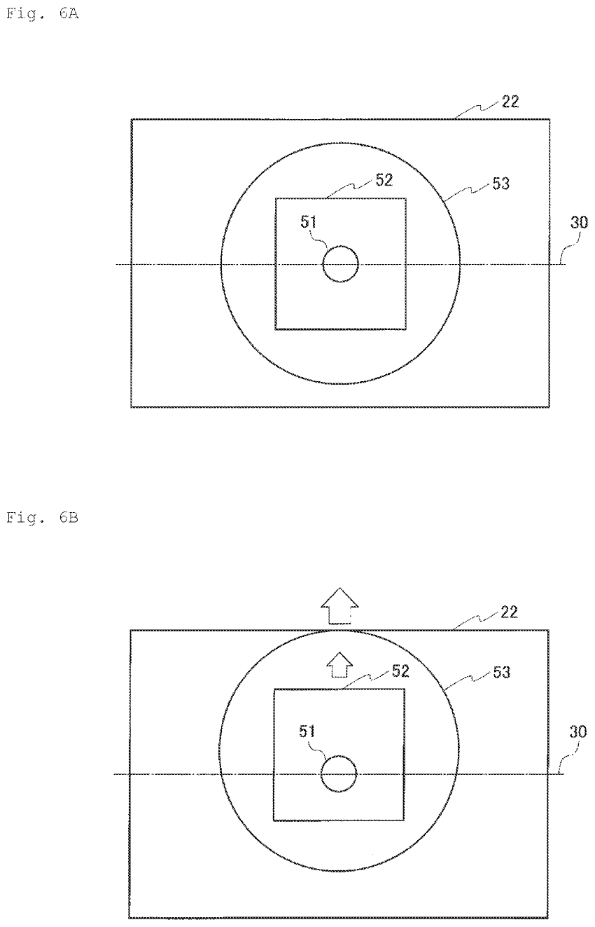

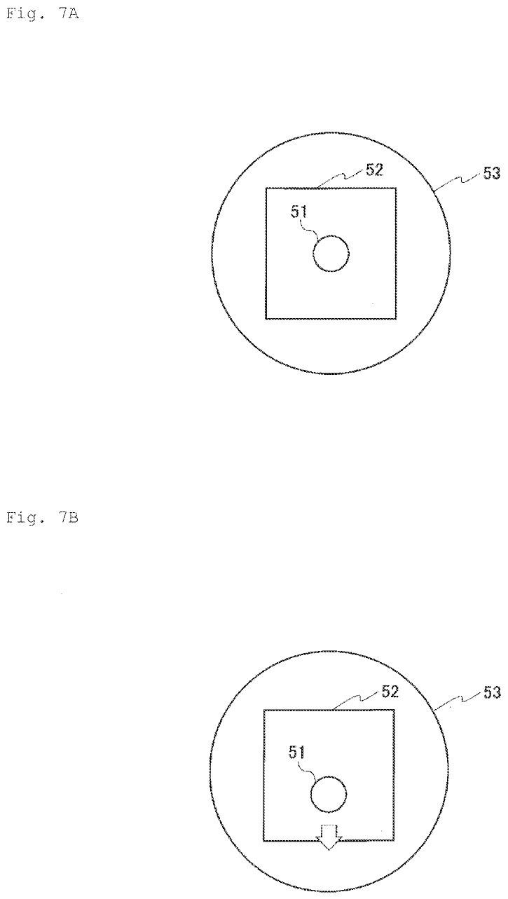

In the second embodiment, as illustrated in FIG. 6A, an induced motion is produced in the visual target 51 even in a dim environment by displaying an induction background video 53 surrounding the background video 52 and separately moving the background videos 52 and 53. The display environment condition of the second embodiment may not be a state in which a nearby device is completely out of view when the environment condition is dim.

The video processing device 10 according to the second embodiment includes the setting unit 11, the control unit 12, and the output unit 13 as in the first embodiment.

The setting unit 11 disposes an induction object surrounding the floor surface object at an initial position in the virtual space in addition to the visual target object and the floor surface object. For example, the setting unit 11 disposes the induction object displayed like a spotlight in which the background video 53 illuminates the visual target 51.

FIG. 6A illustrates examples of the visual target 51 displayed on the virtual image surface 30 and the background videos 52 and 53 projected to the screen 22. FIG. 6A is a diagram illustrating a bird's-eye view of the screen 22. The background video 52 is a video such as a floor surface or the ground surrounding the visual target 51 as in the first embodiment. The background video 53 is a figure surrounding the background video 52 and any shape, pattern, and color can be set. In the embodiment, the background video 53 has a circle and is set as a figure like a spotlight in which the visual target 51 is illuminated.

The control unit 12 moves the induction object based on a movement amount of the floor surface object. Specifically, the control unit 12 moves the induction object in the same direction as the movement direction of the floor surface object so that the movement amount of the induction object is greater than the movement amount of the floor surface object. For example, when the movement amount of the floor surface object is v, the movement amount of the induction object is set to 2v. The movement amount of the induction object may be greater than the movement amount of the floor surface object.

FIG. 6B illustrates a display example when the background videos 52 and 53 are moved upward in the drawing from the state of FIG. 6A. The display position of the visual target 51 is not moved. By setting the movement amount of the background video 53 to be greater than the movement amount of the background video 52, the background video 52 is induced in an opposite direction (the reverse direction to the movement direction of the background video 52) relatively to the background video 53. As a result, the background video 52 is perceived as if the background video 52 was still because an induced motion and a physical motion in which the display position is moved are offset each other.

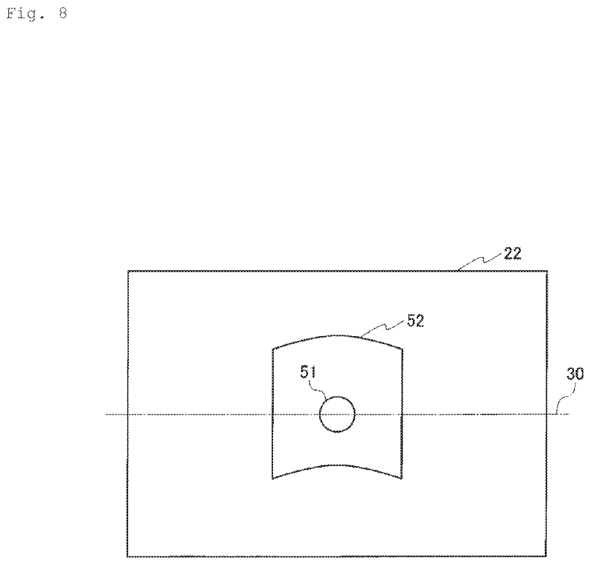

Although the periphery of the observer and the display system is dim, the observer perceives the background video 52 as still and the visual target 51 as moving from the contrast between the background videos 52 and 53 when the background videos 52 and 53 are separately moved, as illustrated in FIGS. 7A and 7B.

In the foregoing case, the movement of the background video 53 is perceived. Therefore, the background video 53 may be displayed in an aspect in which the observer can perceive the background video 53 which does not give a discomfort despite the movement. For example, by displaying the background video 53 in an aspect of a spotlight in which the visual target 51 is illuminated, it is possible to expect the advantageous effect of reducing the discomfort about existence of the background video 53.

The output unit 13 outputs a video including the induction object and the floor surface object imaged by the background virtual camera to the background video output device 21.

An operation of the video processing device 10 according to the second embodiment is basically similar to the flowchart of FIG. 5.

In step S11, the setting unit 11 disposes the floor surface object and the induction object at initial positions based on the positional relation between the visual target and the screen 22.

In step S12, the control unit 12 calculates a movement amount of the floor surface object and the induction object corresponding to one frame based on a movement amount of the visual target corresponding to one frame and moves the floor surface object and the induction object based on the calculated movement amount.

In step S13, the output unit 13 outputs the background video obtained by imaging a plane including the floor surface object and the induction object using the virtual camera to the background video output device 21.

As described above, the display system according to the embodiment displays the background video 52 surrounding the visual target 51 and the induction background video 53 surrounding the background video 52 on the screen 22 and moves the background videos 52 and 53 in the opposite direction to the direction in which the visual target 51 is desired to be moved, so that the movement amount of the induction background video 53 is greater than the movement amount of the background video 52, and thus the observer 100 can perceive the visual target 51 as moving in the background video 52 in the dim environment.

### Third Embodiment

Next, a display system according to a third embodiment will be described. A configuration of the display system according to the third embodiment is the same as that of the display system according to the first and second embodiments.

When the movement amount of the background video surrounding the visual target is set to be large in order to move the visual target fast, there is concern of movement of the background video being perceived.

In the third embodiment, by moving a part of the background video, as illustrated in FIG. 8, rather than moving the whole background video, it is possible to inhibit the observer 100 from perceiving the movement of the background video.

The video processing device 10 according to the third embodiment includes the setting unit 11, the control unit 12, and the output unit 13 as in the first embodiment.

The setting unit 11 disposes a floor surface object at the initial position in the virtual space as in the first embodiment. The setting unit 11 may dispose an induction object surrounding the floor surface object as in the second embodiment.

The control unit 12 sets a different movement amount of each portion of the background video 52, that is, the floor surface object, to move each portion of the background video 52 based on a movement amount of the visual target 51. In the example of FIG. 8, the background video 52 of the visual target 51 in the movement direction is moved fast and is moved slowly away in the movement direction. When the induction object is disposed, the control unit 12 moves the induction object as in the second embodiment.

A movement example of the background video 52 when the background video 52 is rectangular will be described specifically. The floor surface object is rectangular and a circle circumscribing four sides of the rectangle is assumed. The control unit 12 moves the circle in the opposite direction to the movement direction of the visual target 51. At this time, the corners of the floor surface object may be fixed or may be moved with a movement amount less than the movement amount of the circle. The control unit 12 deforms the sides so that the sides of the floor surface object in the movement direction of the visual target 51 come into contact with the circle after the movement. The control unit 12 also performs the same deformation on the facing sides.

The sides of the background video 52 may be blurred so that the deformation of the sides of the background video 52 are not conspicuous.

When the background video 52 is configured by a collection of points, for example, the control unit 12 fast moves points at which an existence direction of the points is close to the movement direction of the visual target 51 and slowly moves points at which an existence direction of the points is different from the movement direction.

The output unit 13 outputs the floor surface object imaged by the virtual camera to the background video output device 21.

An operation of the video processing device 10 according to the third embodiment is basically similar to the flowchart of FIG. 5.

In step S11, the setting unit 11 disposes the floor surface object at an initial position based on the positional relation between the visual target and the screen 22.

In step S12, the control unit 12 calculates a movement amount of each portion of the floor surface object corresponding to one frame based on a movement amount of the visual target corresponding to one frame and moves each portion of the floor surface object based on the calculated movement amount.

In step S13, the output unit 13 outputs the background video obtained by imaging a plane including the floor surface object using the virtual camera to the background video output device 21.

As described above, the display system according to the embodiment moves each portion of the background video 52 by a different movement amount based on the movement direction of the visual target 51 when the visual target 51 is desired to be displayed so that the visual target 51 is moving fast, and thus it is possible to inhibit the observer from perceiving the movement of the background video 52.

### Fourth Embodiment

Next, a display system according to a fourth embodiment will be described. A display system according to the fourth embodiment displays a visual target which can be observed in two or more different directions.

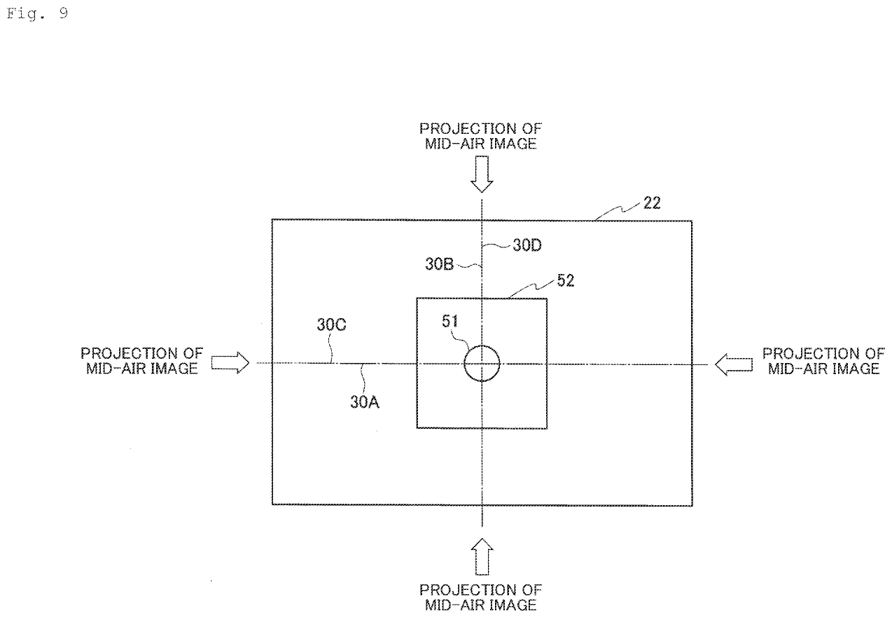

The display system according to the fourth embodiment will be described with reference to FIG. 9. FIG. 9 is a diagram illustrating a bird's-eye view of the display system according to the fourth embodiment. As in the first to third embodiments, the screen 22 is disposed and the background video output device 21 projects the background video 52 to the screen 22.

The video processing device 10 supplies the background video 52 producing an induced motion in the visual target 51 to the background video output device 21. The video processing device 10 may uses any of the first to third embodiments when the background video 52 is supplied.

In the fourth embodiment, four sets of the mid-air image output devices 23 and the optical elements 24 are provided to project a mid-air image to the upper side of the screen 22 in four different directions. The mid-air image output devices 23 and the optical elements 24 are disposed so that the positions of the virtual image surfaces of the facing devices match each other. Specifically, a virtual image surface 30A formed by the mid-air image output device 23 and the optical element 24 disposed downward in the drawing of FIG. 9 matches the position of a virtual image surface 30C formed by the mid-air image output device 23 and the optical element 24 disposed upward. A virtual image surface 30B formed by the mid-air image output device 23 and the optical element 24 disposed to the left in the drawing of FIG. 9 matches the position of a virtual image surface 30D formed by the mid-air image output device 23 and the optical element 24 disposed in the right direction.

The mid-air image output devices 23 display the visual target 51 viewed in each direction at a position at which the virtual image surfaces 30A and 30C intersect the virtual image surfaces 30B and 30D. Thus, the whole circumference of the visual target 51 can be observed. The mid-air image output devices 23 and the optical elements 24 may be disposed so that the virtual image surfaces 30A to 30D are parallel to the normal direction of the screen 22 and the virtual image surfaces 30A and 30C cross the virtual image surfaces 30B and 30D at right angles.

Instead of the optical elements 24, transparent screens may be disposed to correspond to the positions of the virtual image surfaces 30A and 30C and the virtual image surfaces 30B and 30D illustrated in FIG. 9 and the visual target 51 may be projected to the transparent screens in four different directions.

The number of directions in which the visual target 51 is projected is not limited to the four directions and may be two or three directions. In any case, the visual target 51 is projected to a position at which projection surfaces intersect each other.

As described above, the display system according to the embodiment displays the visual target 51 at the position at which the virtual image surfaces 30A to 30D intersect each other on the screen 22, displays the background video 52 on the screen 22, and moves the background video 52 in the opposite direction to the direction in which the visual target 51 is desired to be moved, and thus the whole circumference of the visual target 51 can be perceived so that the visual target 51 is moved on the background video 52.

### Fifth Embodiment

Next, a display system according to a fifth embodiment will be described. A configuration of the display system 1 according to the fifth embodiment is the same as the configuration of the display system 1 illustrated in FIG. 1 according to the first embodiment. The display system 1 includes the video processing device 10, the background video output device 21, the screen 22, the mid-air image output device 23, and the optical element 24. The background video output device 21 and the screen 22 may be a display device with a plane or a shape close to the plane which can display a shadow of a visual target to be described below.

In the display system 1 in FIG. 1, a position of the virtual image surface 30 can be determined in accordance with the positional relation between the mid-air image output device 23 and the optical element 24. The visual target projected to the virtual image surface 30 can be moved freely in the virtual image surface 30 and cannot be moved in the depth direction.

When a viewpoint of the observer 100 is higher than the position of the visual target and the size of the visual target and a display position in the virtual image surface 30 are changed, the observer 100 can perceive movement of the visual target in the depth direction. Further, by making a shadow to the footing of the visual target, it is possible to perceive an absolute position of the visual target on the floor surface.

In the fifth embodiment, by changing the size and position of the visual target and displaying the shadow on the floor surface, it is possible to perceive movement of the visual target in the depth direction. In the fifth embodiment, unlike the first to fourth embodiments, an induced motion is not produced. Therefore, the darkroom condition may not be set.

The video processing device 10 according to the fifth embodiment includes the setting unit 11, the control unit 12, and the output unit 13 as in the first embodiment.

The setting unit 11 disposes a visual target object indicating a visual target and a floor surface object below the visual target object at the initial positions in the virtual space based on a positional relation between the screen 22 and the virtual image surface 30 (the visual target) in the real space. The setting unit 11 disposes a parallel light source illuminating the visual target object from the upper side on the visual target object. The shadow of the visual target is displayed on the floor surface object by the parallel light source. When the visual target object is moved in the virtual space, the shadow is also moved.

The setting unit 11 disposes a background virtual camera that captures a video to be projected to the screen 22 in the virtual space. The background virtual camera images the floor surface object including the shadow displayed on the floor surface object. A video captured by the background virtual camera is projected to the screen 22.

The setting unit 11 may dispose a visual target virtual camera that images the visual target object in the virtual space. A positional relation between the virtual camera and the visual target object in the virtual space is equal to the positional relation between the viewpoint of the observer 100 in the real space and the visual target in the virtual image surface 30, and a projection method is set in a perspective projection method.

The control unit 12 moves the visual target object in the virtual space. The shadow of the visual target object is moved in accordance with the position of the visual target object. In a video captured by the background virtual camera, the shadow of the visual target object is moved in accordance with the position of the visual target object in the virtual space. For the visual target object captured by the visual target virtual camera, a size and a position in the captured video is changed in accordance with a movement amount in the depth direction by the perspective projection method.

The output unit 13 outputs a video including the visual target object imaged by the visual target virtual camera to the mid-air image output device 23 and outputs a video including the floor surface object imaged by the background virtual camera and the shadow to the background video output device 21.

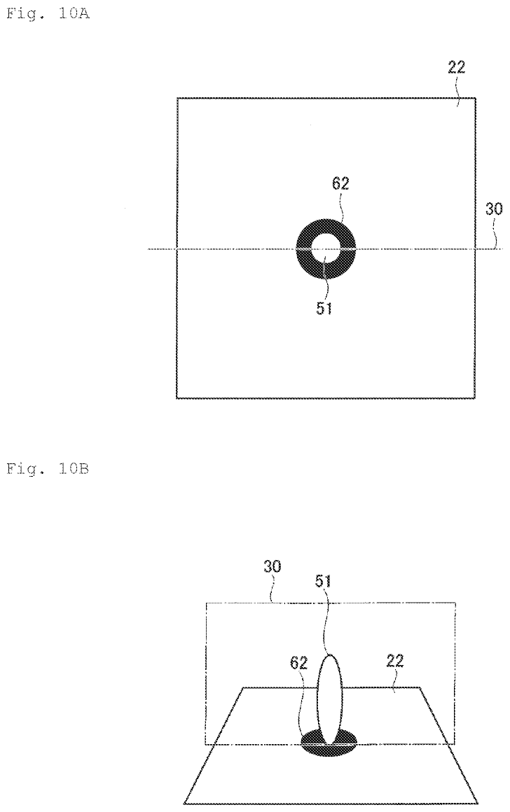

FIG. 10A illustrates an example of the visual target 51 displayed on the virtual image surface 30 and a shadow 62 projected to the screen 22. FIG. 10A is a diagram illustrating a bird's-eye view of the screen 22. The observer 100 is assumed to be located downward in the drawing in front of the center of the screen 22 and the viewpoint of the observer 100 is assumed to be a position of a bird's-eye view of the screen 22 at a position higher than the visual target 51. The visual target 51 is projected to the virtual image surface 30 perpendicular to the screen 22 and a position at which the visual target 51 is displayed is expressed with a circle in FIG. 10A.

FIG. 10A illustrates an example of an initial state. The visual target object in the virtual space is located at the center of the floor surface object and the position in the depth direction is located at a position corresponding to the virtual image surface 30 in the real space. The shadow 62 is displayed below the visual target 51 displayed on the virtual image surface 30. The visual target 51 may be displayed to float in the air or may be displayed to be grounded on the screen 22.

FIG. 10B illustrates how the display state of FIG. 10A appears to the observer 100. As illustrated in FIG. 10B, the visual target 51 is displayed on the virtual image surface 30 and the shadow 62 is displayed on the screen 22 below the visual target 51. Therefore, the observer 100 can perceive an absolute value of the visual target 51 on the screen 22.

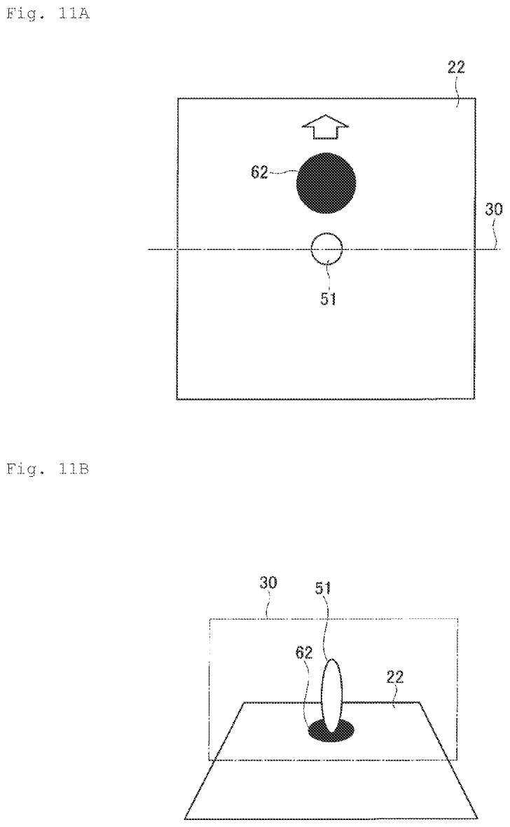

When the visual target object is moved in the depth direction in the virtual space, the shadow of the visual target object displayed on the floor surface object is also moved in the depth direction. As illustrated in FIG. 11A, the shadow 62 is displayed at a position moved in the depth direction. Since the position of the virtual image surface 30 is not moved, the position at which the visual target 51 is displayed in the depth direction is not changed.

The visual target virtual camera images the visual target object by the perspective projection method. Therefore, when the visual target object is moved in the depth direction, the visual target 51 is displayed on the virtual image surface 30 with a size and at a height in accordance with a viewpoint position of the observer 100 and a depth position of the visual target 51 desired to be perceived by the observer 100.

FIG. 11B illustrates how the display state of FIG. 11A appears to the observer 100. When the screen 22 is viewed from the upper side as in FIG. 11A, the visual target 51 and the shadow 62 are separated. However, when the screen 22 is viewed from the observer 100, as illustrated in FIG. 11B, the shadow 62 seems to be located below the visual target 51. The size and position of the visual target 51 on the virtual image surface 30 are changed in accordance with movement of the visual target object in the depth direction, and the shadow 62 is moved to follow the visual target 51. The observer 100 can perceive the position of the shadow 62 as a depth position of the visual target 51.

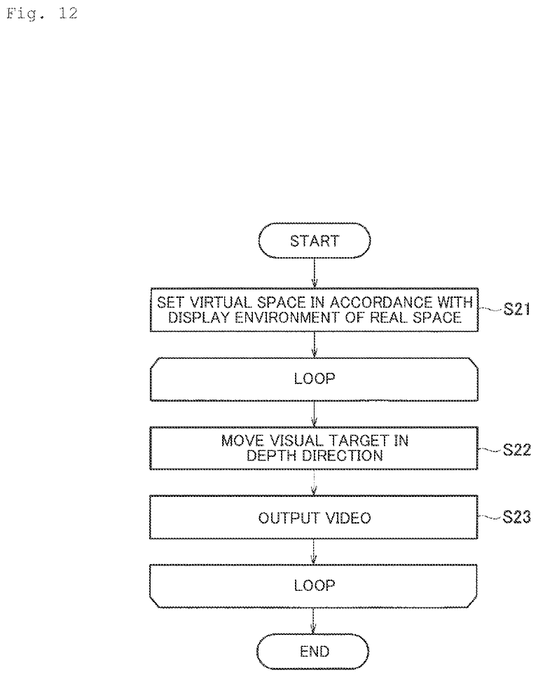

An operation of the video processing device 10 will be described with reference to the flowchart of FIG. 12. The background video output device 21, the screen 22, the mid-air image output device 23, and the optical element 24 are set so that the visual target 51 erect at a desired position on the screen 22 is displayed. This setting is an example of mid-air image display of the visual target 51 and the present invention is not limited thereto.

In step S21, the setting unit 11 disposes the visual target object and the floor surface object at the initial positions in the virtual space and disposes a parallel light source above the visual target object based on a positional relation between the screen 22 and the visual target in the real space. The setting unit 11 disposes a virtual camera that captures the visual target to correspond to a viewpoint position of the observer 100 and disposes a virtual camera that captures a floor surface object in the virtual space.

In step S22, the control unit 12 moves the visual target object in the virtual space. In the virtual space, a shadow is displayed immediately below the visual target object.

In step S23, the output unit 13 outputs a video including the visual target object imaged by the visual target virtual camera to the mid-air image output device 23 and outputs a video including the floor surface object imaged by the background virtual camera and the shadow to the background video output device 21. The visual target 51 is displayed on the virtual image surface 30, and the floor surface and the shadow 62 are displayed on the screen 22.

The processes of steps S22 and S23 are repeatedly performed for each frame.

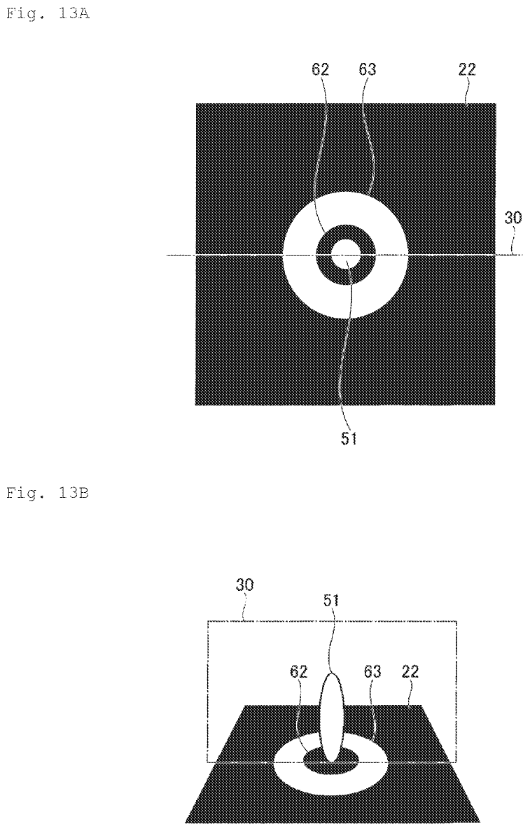

Not a parallel light source but a spotlight may be disposed above the visual target object. In this case, as illustrated in FIG. 13A, the shadow 62 is displayed below the visual target 51 within an irradiation range 63 of the spotlight. FIG. 13B illustrates a way when viewed from the observer 100.

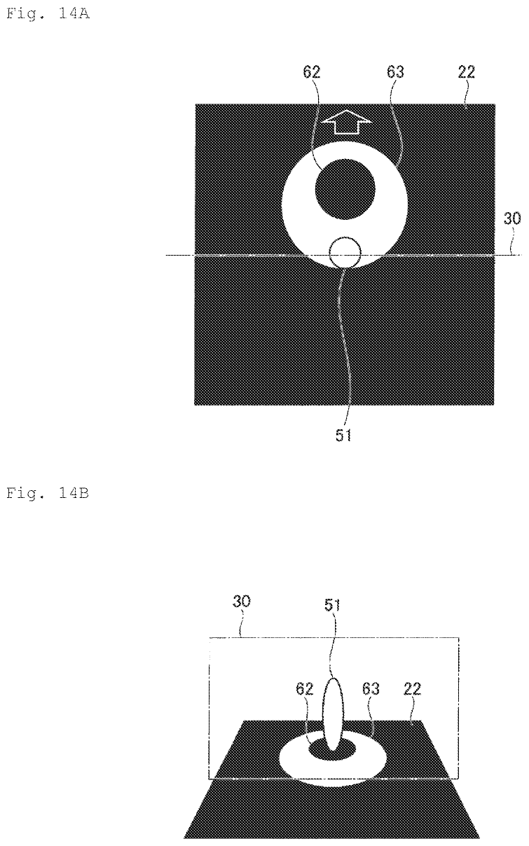

When the visual target object is moved in the depth direction in the virtual space, the spotlight is also moved with the movement of the visual target object. When the visual target object is within the irradiation range of the spotlight, the spotlight may not be moved. The shadow of the visual target object displayed on the floor surface object is also moved in the depth direction. As illustrated in FIG. 14A, the shadow 62 and the irradiation range 63 of the spotlight are displayed at positions moved in the depth direction.

When the visual target object is moved in the depth direction, the visual target object is captured with a size and at a position different from the state of FIG. 13A to be displayed on the virtual image surface 30.

FIG. 14B illustrates how the display state of FIG. 14A appears to the observer 100. When the screen 22 is viewed from the upper side as in FIG. 14A, the visual target 51 and the shadow 62 are separated. However, when viewed from the observer 100, as illustrated in FIG. 14B, the shadow 62 seems to be located below the visual target 51.

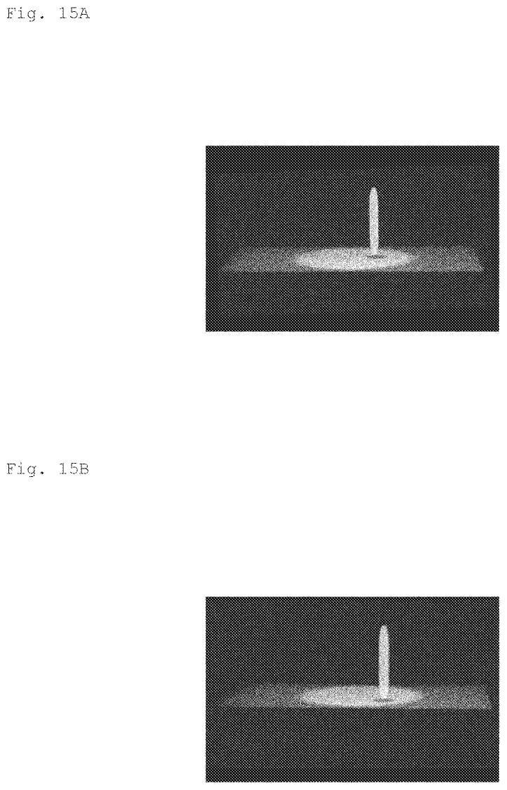

FIGS. 15A and 15B illustrate an example in which the different position of the visual target in the depth direction is displayed. In both of FIGS. 15A and 15B, a position of the virtual image surface 30 with respect to the screen 22 is the same and a display position of the visual target in the depth direction is the same in the real space. By changing the size of the visual target 51 and the display position of the visual target 51 in the virtual image surface 30 and displaying the shadow 62 in the footing of the visual target 51, it is possible to perceive the visual target 51 of FIG. 15A which is on the depth side of the visual target 51 of FIG. 15B.

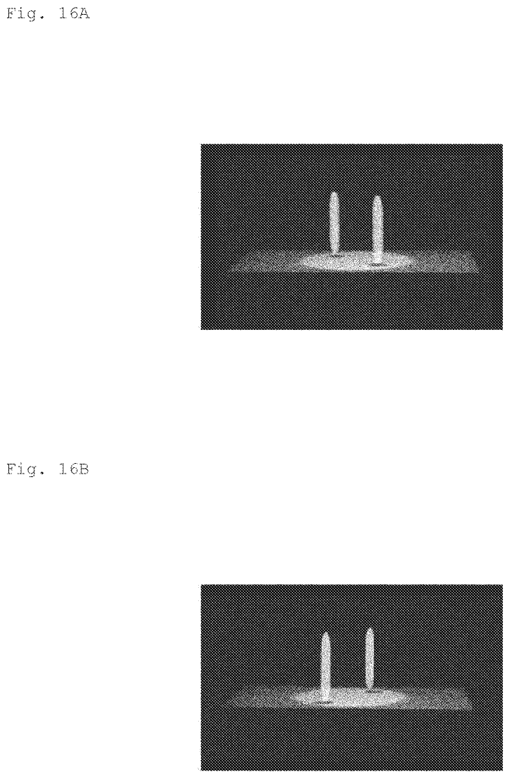

FIGS. 16A and 16B illustrate an example in which different positions of a plurality of visual targets are displayed. In both of FIGS. 16A and 16B, a position of the virtual image surface 30 with respect to the screen 22 is the same and a display position of the visual target 51 in the depth direction in the real space is the same. When there area plurality of visual targets, different movement of the plurality of visual targets to the depth side can be expressed simultaneously by performing the same process.

As described above, the video processing device 10 according to the embodiment disposes the visual target object and the floor surface object at the initial positions in the virtual space based on the positional relation between the screen 22 and the virtual image surface 30 in the real space, disposes the parallel light source illuminating the visual target object, and disposes the background virtual camera that captures the video projected to the screen 22 and the virtual camera that images the visual target object. The video processing device 10 moves the shadow 62 to the position at which the position of the visual target 51 on the depth side is desired to be perceived with the movement of the visual target object and changes the size and the height of the visual target 51 in accordance with the viewpoint position of the observer 100 and the position of the visual target 51 on the depth side. Thus, it is possible to perceive the movement of the visual target 51 in the depth direction on the screen 22.

### Sixth Embodiment

Next, a display system according to a sixth embodiment will be described. The sixth embodiment is different from the fifth embodiment in that a light source is disposed upward obliquely in the lateral direction of the visual target object in the virtual space. The others are the same as the fifth embodiment.

In the fifth embodiment, it is assumed that the observer 100 views the visual target 51 on the front side of the screen 22. When the observer 100 moves to the right or left of the front or the plurality of observers 100 are lined in the right and left directions, the visual target 51 and the shadow 62 are separated, and thus there is the problem of a way of being unnaturally viewed.

In the sixth embodiment, a light source is disposed upward obliquely in the lateral direction of the visual target object and a laterally long shadow is displayed.

The video processing device 10 according to the sixth embodiment includes the setting unit 11, the control unit 12, and the output unit 13 as in the fifth embodiment.

As in the fifth embodiment, the setting unit 11 disposes a visual target object indicating a visual target and a floor surface object at the initial positions in the virtual space based on a positional relation between the screen 22 and the visual target in the real space and disposes a background virtual camera that images the floor surface object including the shadow displayed on the floor surface object and a visual target visual camera that images the visual target object.

The setting unit 11 disposes a parallel light source illuminating the visual target object upward obliquely in the lateral direction at the same depth position as the visual target object. A laterally long shadow of the visual target is displayed on the floor surface object by the parallel light source.

The control unit 12 moves the visual target object in the virtual space as in the fifth embodiment. For the visual target object captured by the visual target virtual camera, a size and a position in the captured video is changed in accordance with a movement amount in the depth direction by the perspective projection method.

As in the fifth embodiment, the output unit 13 outputs a video including the visual target object imaged by the visual target virtual camera to the mid-air image output device 23 and outputs a video including the floor surface object imaged by the background virtual camera and the shadow to the background video output device 21.

A flow of the process of the video processing device 10 according to the sixth embodiment is the same as the flow of the process of the video processing device 10 described with reference to FIG. 12 in the fifth embodiment.

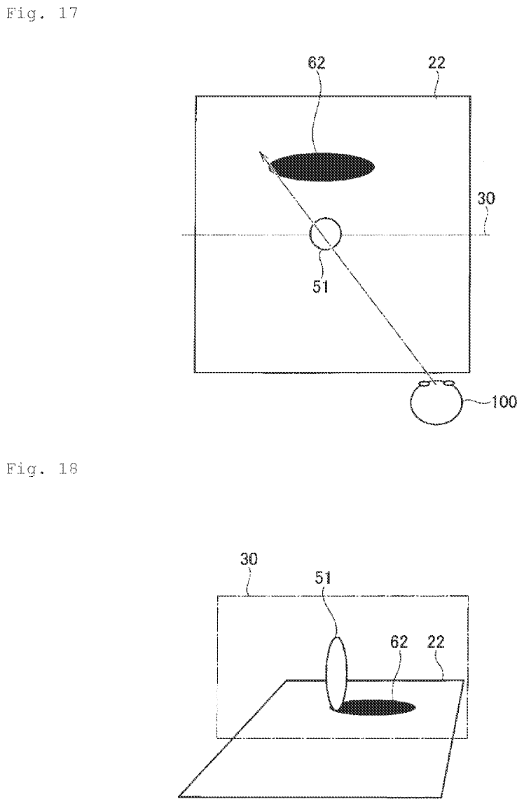

FIG. 17 illustrates examples of the visual target 51 displayed on the virtual image surface 30 and the shadow 62 projected to the screen 22 in the bird's-eye view of the screen 22. The observer 100 is located downward in the drawing on the right side of the screen 22. Since the light source is disposed to the left in the drawing, the laterally long shadow 62 growing on the right side on the floor surface object is displayed. As illustrated in FIG. 18, the shadow 62 growing from the visual target 51 to the right side seems to be located from the observer 100 on the right side.

When the observer 100 views in the front of the center of the screen 22 in the display state of FIG. 17, the visual target 51 and the shadow 62 are displayed not to be separated and the shadow 62 in the lateral direction is displayed immediately below the visual target 51.

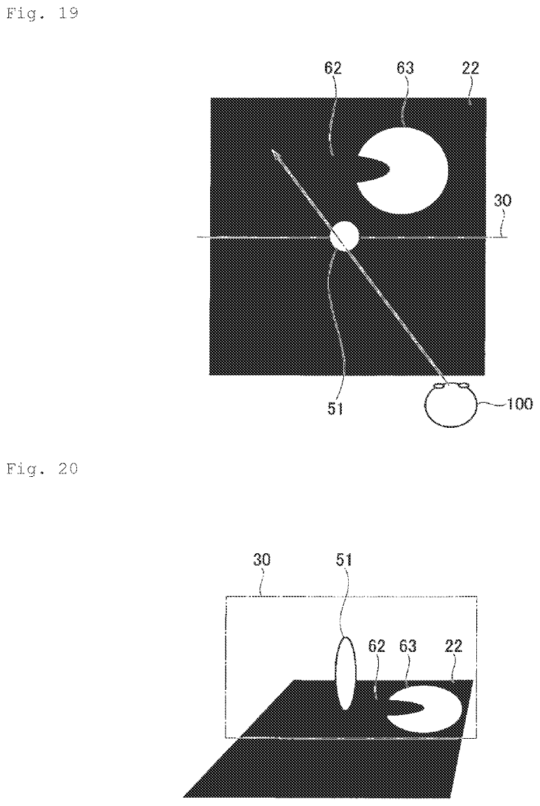

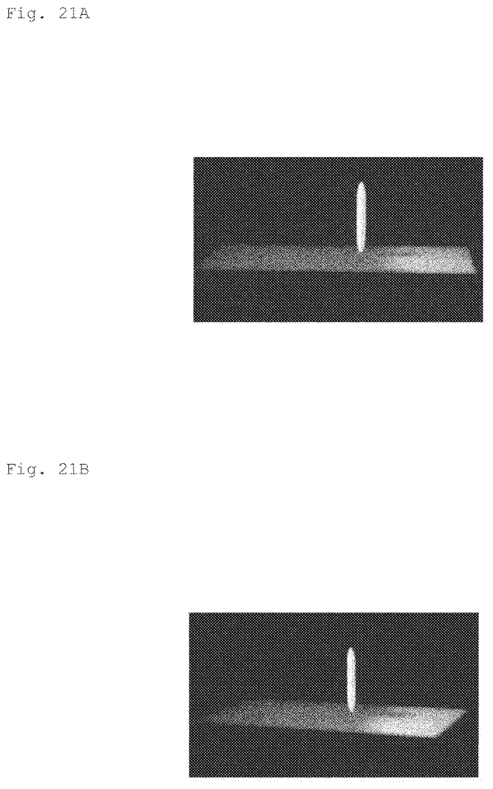

Not the parallel light source but a spotlight with which the upper portion of the visual target object is illuminated may be disposed. A range outside of the irradiation range of the spotlight is set to be dark so that the shadow of the visual target object cannot be distinguished. In this case, as illustrated in FIG. 19, only the shadow 62 of the upper portion of the visual target object is displayed within the irradiation range 63 of the spotlight. FIG. 20 illustrates a way when viewed from the observer 100.

As illustrated in FIG. 20, it is difficult to distinguish whether footing of the visual target 51 is separated from the shadow 62. When light is radiated in the lateral direction, the depth position of the shadow 62 can be perceived as the depth position of the visual target 51 as it is.

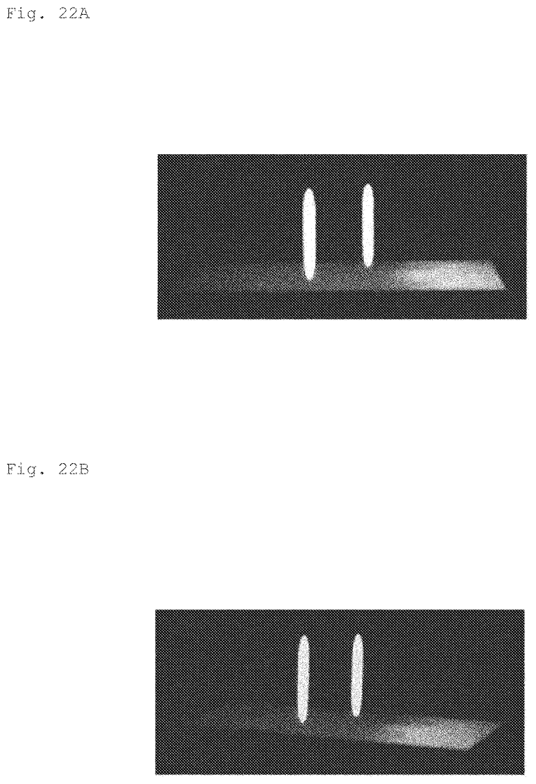

FIGS. 21A and 21B illustrate an example in which the visual target is viewed from the front side and the right side when the spotlight with which the upper portion of the visual target object is illuminated upward obliquely on the lateral side is disposed and the visual target is displayed. Either FIG. 21A or 21B, a position in the depth direction can be perceived by the shadow 62 of the upper portion of the visual target 51 displayed within the irradiation range 63. Since it is difficult to distinguish whether the footing of the visual target 51 is separated from the shadow 62, the visual target 51 and the shadow 62 are not unnaturally viewed in the way.

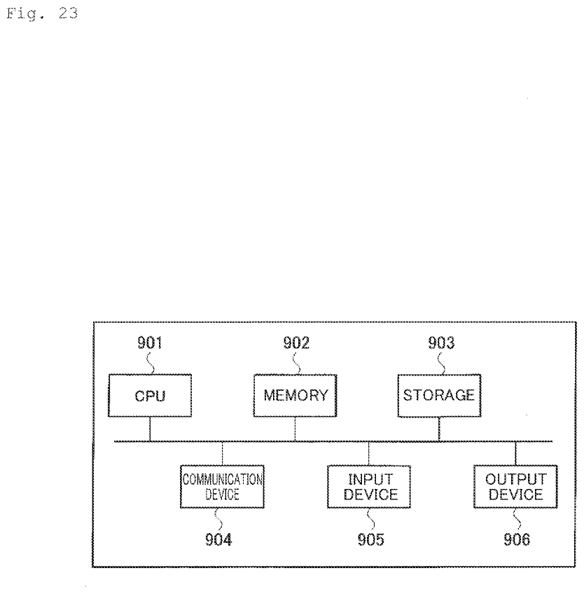

FIGS. 22A and 22B illustrate an example in which a plurality of visual target objects are disposed and the visual targets are viewed from the front side and the right side when a spotlight with which the upper portions of the visual target objects are illuminated upward obliquely on the lateral side is disposed and the visual targets are displayed. When there are the plurality of visual targets, an unnatural viewing way can also be solved by performing the same process.

As described above, the video processing device 10 according to the embodiment disposes the light source upward obliquely in the lateral direction of the visual target object and displays the shadow 62 growing in the lateral direction. Thus, when an angle of the visual target 51 viewed by the observer 100 is different, it is possible to inhibit the visual target 51 and the shadow 62 from being separately displayed.

The video processing device 10 according to the embodiment disposes the spotlight light source upward obliquely in the lateral direction of the visual target object and displays the shadow 62 of the upper portion of the visual target 51 within the irradiation range of the spotlight. Thus, it is difficult to distinguish whether the footing of the visual target 51 is separated from the shadow 62.

The video processing method according to the sixth embodiment may be applied to the display system that has four virtual image surfaces according to the fourth embodiment. Thus, it is possible to express the movement of the visual target in the depth direction with respect to the observer viewing the whole circumference.

In the above-described video processing device 10, for example, a general-purpose computer system that includes a central processing unit (CPU) 901, a memory 902, a storage 903, a communication device 904, an input device 905, and an output device 906, as illustrated in FIG. 23, can be used. In the computer system, the CPU 901 realizes the video processing device 10 by executing a predetermined program loaded on the memory 902. The program can be recorded on a computer-readable recording medium such as a magnetic disk, an optical disc, or a semiconductor memory or can also be delivered via a network.

### REFERENCE SIGNS LIST

1 Display system
10 Video processing device
11 Setting unit
12 Control unit
13 Output unit
21 Background video output device
22 Screen
23 Mid-air image output device
24 Optical element
30, 30A, 30B, 30C, 30D Virtual image surface
51 Visual target
52, 53 Background video
62 Shadow
63 Irradiation range
100 Observer

1. A video processing device that outputs a video in which movement in a depth direction of a visual target of which movement in the depth direction is fixed on a display surface of a display device is perceived, the video processing device comprising:
an output unit, implemented using one or more computing devices, configured to output a video corresponding to a position of the visual target to the display device; and
a control unit, implemented using one or more computing devices, configured to move the video in a direction in which the movement of the visual target in the depth direction is perceived.

2. The video processing device according to claim 1,
wherein the video is a background video producing an induced motion in the visual target,
wherein the output unit outputs the background video surrounding the visual target to the display device, and
wherein the control unit moves the background video in an opposite direction to a direction in which the visual target is desired to be moved.

3. The video processing device according to claim 2,
wherein the output unit outputs a second background video surrounding the background video, and
wherein the control unit moves the second background video in a direction which is the same as a movement direction of the background video and sets a movement amount of the second background video to be greater than a movement amount of the background video.

4. The video processing device according to claim 3, wherein a display aspect of the second background video is a spotlight in which the visual target is illuminated.

5. The video processing device according to claim 2, wherein the control unit causes a movement amount of each portion of the background video to differ based on a movement direction of the visual target.

6. The video processing device according to claim 1, further comprising:
a mid-air image output device, implemented using one or more computing devices, displays the visual target on a virtual image surface above a display surface of the display device,
wherein the video is a shadow of the visual target,
wherein the output unit outputs the shadow of the visual target to the display device and outputs a video of the visual target to the mid-air image output device, and wherein the control unit moves the shadow of the visual target to a position at which a depth position of the visual target is desired to be perceived and changes a size and a height of the visual target in accordance with a viewpoint position and the depth position of the visual target.

7. The video processing device according to claim 6, wherein the shadow of the visual target is a shadow growing in a lateral direction at the depth position of the visual target.

8. The video processing device according to claim 7, wherein the output unit outputs a video indicating an irradiation range in an aspect in which an upper portion of the visual target is illuminated in a spotlight in the lateral direction and displays the shadow of the visual target corresponding to the upper portion of the visual target within the video indicating the irradiation range.

9. A display system comprising:
a plurality of display devices; and
a video processing device including one or more computing devices,
wherein each of the plurality of display devices displays a visual target at a position at which projection surfaces above display surfaces of the display devices intersect each other, and
wherein the video processing device includes:
an output unit, implemented using one or more computing devices, that outputs a background video surrounding the visual target to the display device, and
a control unit, implemented using one or more computing devices, that moves the background video in an opposite direction to a direction in which the visual target is desired to be moved.

10. (canceled)

11. A non-transitory recording medium storing a program, wherein execution of the program causes one or more computers of each unit of a video processing device to perform operations comprising:
outputting a video of which movement in a depth direction of a visual target of which movement in the depth direction is fixed on a display surface of a display device is perceived;
outputting a video corresponding to a position of the visual target to the display device; and
moving the video in a direction in which the movement of the visual target in the depth direction is perceived.
